(19) United States
(12) Patent Application Publication
(10) Pub. No.: US 2012/0327078 A1
(43) Pub. Date: Dec. 27, 2012

(54) APPARATUS FOR RENDERING 3D IMAGES

(76) Inventors: Wen-Tsai LIAO, New Taipei City (TW); Yi-Shu Chang, Hsinchu County (TW); Hsu-Jung Tung, Zhubei City (TW)

(21) Appl. No.: 13/529,527

(22) Filed: Jun. 21, 2012

(30) Foreign Application Priority Data
Jun. 22, 2011 (TW) 100121904

(51) Int. Cl. G06T 15/00

(52) U.S. Cl. 345/419

(57) ABSTRACT

A 3D image rendering apparatus is disclosed including: an image motion detector for detecting temporal image motion of a target image object in a first left-eye image or a first right-eye image to generate a temporal motion vector, and for performing image motion detection on the first left-eye image and the first right-eye image to generate a spatial motion vector for the target image object; a depth generator for generating a depth value for the target image object based on the temporal motion vector and the spatial motion vector; an command receiving device for receiving a depth adjusting command; and an image rendering device for adjusting the image position of at least part of image objects in the first left-eye image and the first right-eye image to render a second left-eye image and a second right-eye image.

### CROSS-REFERENCE TO RELATED APPLICATIONS

This application claims the benefit of priority to Taiwanese Patent Application No. 100121904, filed on Jun. 22, 2011; the entirety of which is incorporated herein by reference for all purposes.

### BACKGROUND

The present disclosure generally relates to 3D image display technology and, more particularly, to 3D image rendering apparatuses capable of adjusting depth of 3D image objects.

With the technology progress, 3D image display application has become more and more popular. When producing 3D stereo visual effect, some 3D image rendering technologies require additional devices, such as specialized glasses or helmet, and other technical solutions need not. The 3D image rendering technologies provide more stereo visual effect, but different observers have different sensitivity and perception. Therefore, same 3D image may be found not stereo enough to some people, but may cause dizziness to other people.

Unfortunately, due to the limitation on the format of source image data or transmission bandwidth, the traditional 3D image display system is unable to allow the users to adjust the depth configuration of 3D images depending upon their visual perception, and thus not able to provide desirable viewing quality or may cause the observers to feel uncomfortable when viewing 3D images.

### SUMMARY

In view of the foregoing, it can be appreciated that a substantial need exists for apparatuses that can allow the observer to adjust the depth configuration of 3D images depending upon their visual perception.

A 3D image rendering apparatus is disclosed comprising:

It is to be understood that both the foregoing general description and the following detailed description are example and explanatory only and are not restrictive of the invention, as claimed.

### BRIEF DESCRIPTION OF THE DRAWINGS

FIG. 1 is a simplified functional block diagram of a 3D image rendering apparatus according to an example embodiment.

FIG. 2 is a simplified flowchart illustrating a method for rendering 3D image in accordance with an example embodiment.

FIG. 3 is a simplified schematic diagram of left-eye images and right-eye images with respect to different time points according to an example embodiment.

FIG. 4 is a simplified schematic diagram of a left-eye image and a right-eye image received by the 3D image rendering apparatus of FIG. 1 according to an example embodiment.

FIG. 5 is a simplified schematic diagram of a left-eye depth map and a right-eye depth map generated by the 3D image rendering apparatus of FIG. 1 according to an example embodiment.

FIG. 6 is a simplified schematic diagram of a left-eye image and a right-eye image synthesized by the 3D image rendering apparatus of FIG. 1 according to an example embodiment.

FIG. 7 is a simplified schematic diagram illustrating the operation of adjusting depth of 3D images performed by the 3D image rendering apparatus of FIG. 1 according to an example embodiment.

FIG. 8 is a simplified schematic diagram of a left-eye depth map and a right-eye depth map generated by the 3D image rendering apparatus of FIG. 1 according to another example embodiment.

### DETAILED DESCRIPTION

Reference will now be made in detail to embodiments of the invention, which are illustrated in the accompanying drawings.

The same reference numbers may be used throughout the drawings to refer to the same or like parts or components. Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

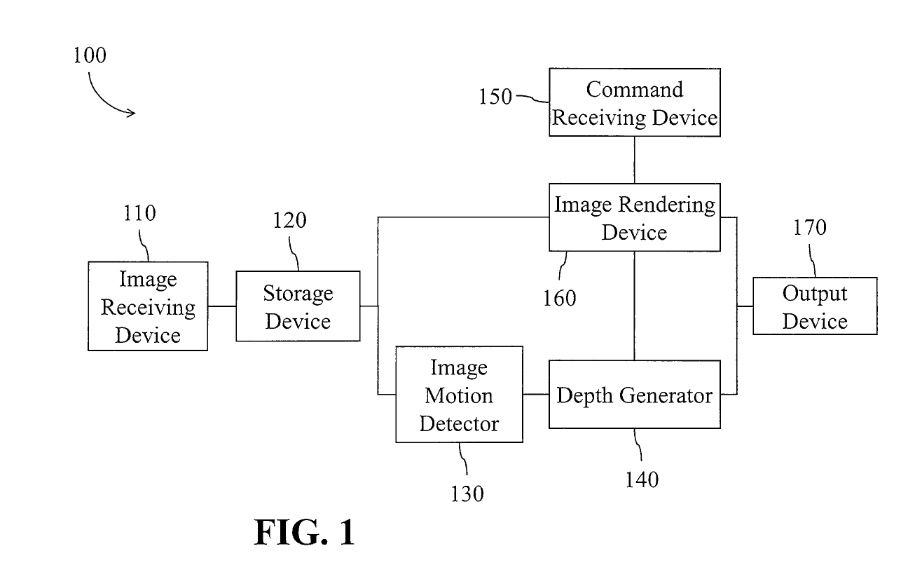

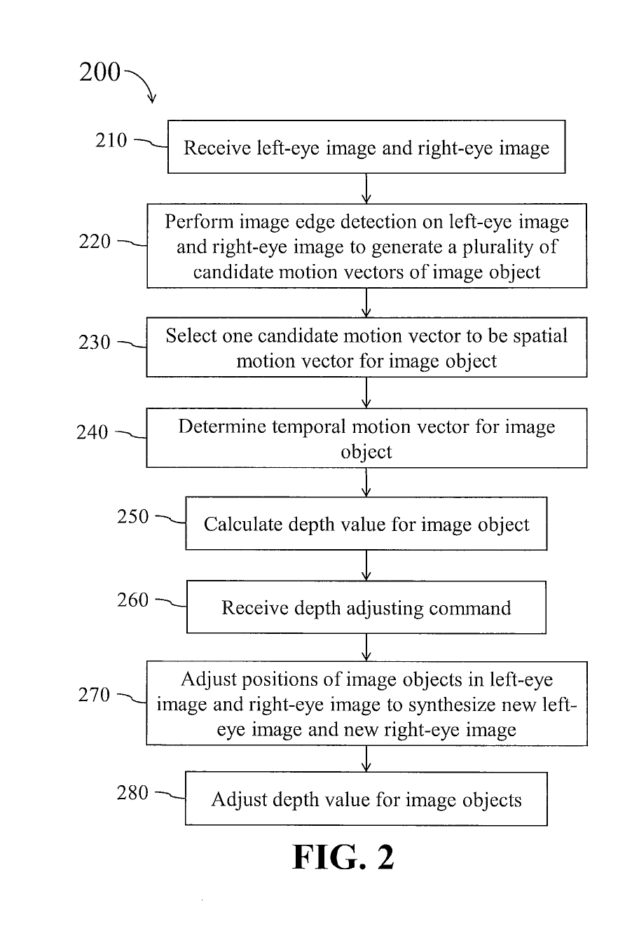

FIG. 1 is a simplified functional block diagram of a 3D image rendering apparatus 100 according to an example embodiment. The 3D image rendering apparatus 100 comprises an image receiving device 110, a storage device 120, an image motion detector 130, a depth generator 140, a command receiving device 150, an image rendering device 160, and an output device 170. In implementations, different functional blocks of the 3D image rendering apparatus 100 may be respectively realized by different circuit components. Alternatively, some or all functional blocks of the 3D image rendering apparatus 100 may be integrated into a single circuit chip. In implementations, the storage device 120 may be arranged inside or outside the image receiving device 110. The operations of the 3D image rendering apparatus 100 will be further described with reference to FIG. 2 through FIG. 8.

FIG. 2 is a simplified flowchart 200 illustrating a method for rendering 3D image in accordance with an example embodiment. In operation 210, the image receiving device 110 receives a left-eye image and a right-eye image capable of forming a 3D image from an image data source (not shown). The image data source may be any device capable of providing left-eye 3D image data and right-eye 3D image data, such as a computer, a DVD player, a signal wire of a cable TV, an Internet device, or a mobile computing device. In this embodiment, the image data source needs not to transmit depth map data to the image receiving device 110.

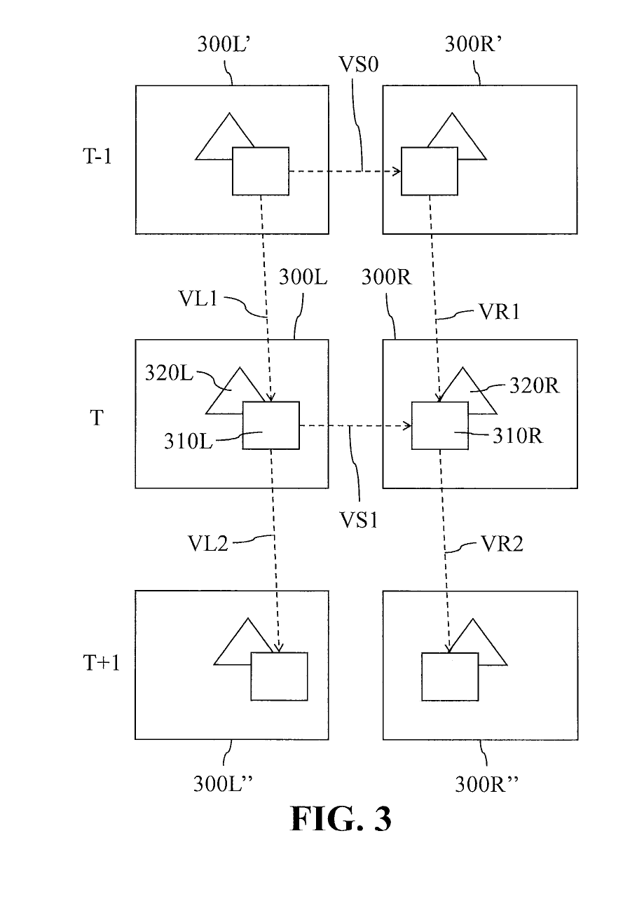

In operations, data of the left-eye image and the right-eye image received by the image receiving device 110 is temporarily stored in the storage device 120 for use in image processing operations. For example, FIG. 3 is a simplified schematic diagram of left-eye images and right-eye images with respect to different time points according to an example embodiment. In FIG. 3, the left-eye image 300L′ and the right-eye image 300R′ correspond to time T−1, the left-eye image 300L and the right-eye image 300R correspond to time T, and the left-eye image 300L″ and the right-eye image 300R″ correspond to time T+1. Each pair of left-eye image and right-eye image is for forming a 3D image when displayed by a display device (not shown) of the subsequent stage.

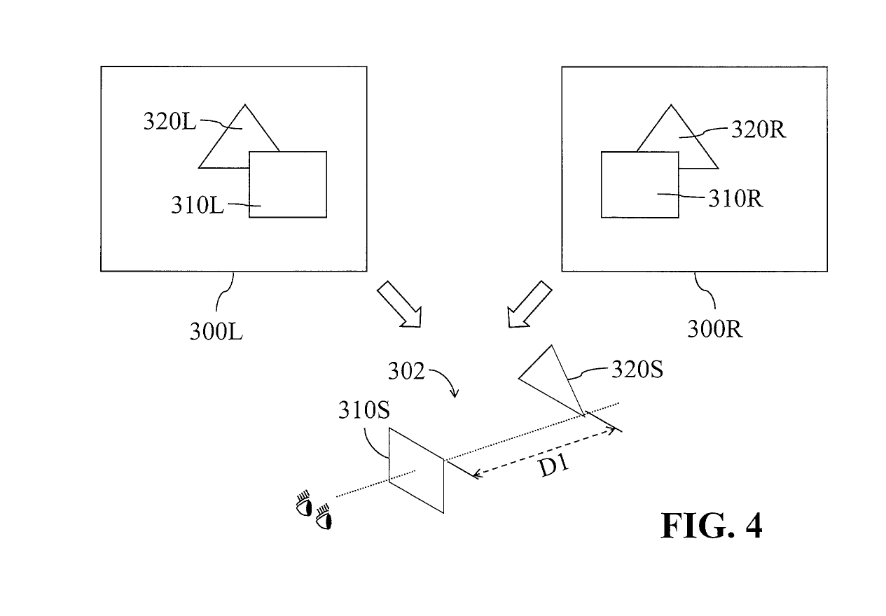

For example, FIG. 4 is a simplified schematic diagram of a 3D image 302 formed by a left-eye image 300L and a right-eye image 300R corresponding to the time T according to an example embodiment. In this embodiment, the image object 310L of the left-eye image 300L and the image object 310R of the right-eye image 300R form a 3D image object 310S in the 3D image 302, and the image object 320L of the left-eye image 300L and the image object 320R of the right-eye image 300R form another 3D image object 320S behind the 3D image object 310S in the 3D image 302. In practical applications, the afore-mentioned display device may be a glasses-free 3D display device adopting auto-stereoscopic technology or a 3D display device that cooperates with specialized glasses or helmet when displaying 3D images.

The outline of each image object may be recognized by human eyes, but in most application environments the aforementioned image data source does not provide reference data of image objects, such as shape and position, to the 3D image rendering apparatus 100. In such case, the image motion detector 130 may proceed to operations 220 and 230 to perform image edge detection and image motion detection on the left-eye image and the right-eye image to recognize corresponding image objects in the left-eye image and the right-eye image. Then, the image motion detector 130 determines the position difference between the corresponding image objects of the left-eye image and the right-eye image. The term “corresponding image objects” as used herein refers to an image object in the left-eye image and an image object the right-eye image that represent the same physical object. Please note that the corresponding image objects in the left-eye image and the right-eye image may not completely identical to each other as the two image objects may have a slight position difference due to the camera angle or due to the parallax process.

For example, the image motion detector 130 may perform image edge detection on the left-eye image 300L and the right-eye image 300R in operation 220 to generate a plurality of candidate motion vectors corresponding to a target image object in the left-eye image 300L or the right-eye image 300R. For the purpose of explanatory convenience in the following description, it is assumed herein that the image object 310L of the left-eye image 300L is the target image object. In this case, the image motion detector 130 may first perform an image edge detection operation on the left-eye image 300L to recognize the outline of the image object 310L in the left-eye image 300, and then detect image motion of the image object 310L between the left-eye image 300L and the right-eye image 300R.

In general, a physical object's image represented in the left-eye image and the physical object's image represented in the right-eye image have the same or close horizontal position. Accordingly, when performing motion detection for the image object 310L, the image motion detector 130 may restrict the image searching area to be within a belt area in the right-eye image 300R to reduce required memory and time consumption for motion detection operation. For example, assuming that a vertical coordinate of the bottom of the image object 310L in the left-eye image 300L is Yb, and a vertical coordinate of the top of the image object 310L is Yu, which is greater than Yb, then the image searching area for the motion detection operation of the image object 310L may be restricted to a belt area of the right-eye image 300R ranging from the vertical coordinates Yb−k˜Yu+k, wherein k may be an appropriate length in a basis of pixel count.

Additionally, in order to reduce the possibility of erroneous motion detection results caused by image noise or other image characteristics, the image motion detector 130 generates a plurality of candidate motion vectors corresponding to the image object 310L in the operation 220.

In operation 230, the image motion detector 130 selects one of the candidate motion vectors generated in the operation 220 to be a spatial motion vector VS1 of the target image object. Since images of approaching time points are highly similar to each other, the image motion detector 130 may determine a current spatial motion vector for the target image object by referencing to the spatial motion vector of the target image object with respect to a previous time point, to improve the accuracy of motion detection for the target image object. For example, the image motion detector 130 may select a candidate motion vector, which is closest to the spatial motion vector VS0 of the image object 310L between the left-eye image 300L′ and the right-eye image 300R′ corresponding to the time point T−1, from the plurality of candidate motion vectors of the image object 310L to be a spatial motion vector VS1 of the image object 310L between the left-eye image 300L and the right-eye image 300R corresponding to the time point T.

In operation 240, the image motion detector 130 determines a temporal motion vector for the target image object. For example, the image motion detector 130 may detect the image motion of the image object 310L between the left-eye image 300L′ and the left-eye image 300L to generate a temporal motion vector VL1.

In operation 250, the depth generator 140 calculates a depth value for the target image object according to the spatial motion vector and the temporal motion vector of the target image object. For example, the depth generator 140 may calculate a depth value for the image object 310L according to the spatial motion vector VS1 of the image object 310L, and then determine whether to fine tune the depth value according to the temporal motion vector VL1 of the image object 310L.

In one embodiment, if the spatial motion vector VS1 is greater than a predetermined value STH1, the depth generator 140 determines that the depth of the image object 310L and the image object 310R is within a segment closer to the observer. That is, the depth of the 3D image object 310S in the 3D image 302 formed by the image object 310L and the image object 310R is within a segment closer to the observer. Accordingly, the depth generator 140 assigns a relatively-larger depth value for pixels corresponding to the image object 310L in the left-eye image 300L, and/or assigns a relatively-larger depth value for pixels corresponding to the image object 310R in the right-eye image 300R. In this embodiment, a relatively-larger depth value corresponds to relatively-lighter depth, i.e., it means that the image object is closer to the video camera (or the observer). On the contrary, a relatively-smaller depth value corresponds to relatively-greater depth, i.e., it means that the image object is further away from the video camera (or the observer).

Then, the depth generator 140 determines whether to further adjust the depth value assigned previously by referencing to the temporal motion vector VL1. In one embodiment, for example, if the temporal motion vector VL1 is greater than a predetermined value TTH1, the depth generator 140 would not further adjust the depth value assigned previously. If the temporal motion vector VL1 is less than a predetermined value TTH2, the depth generator 140 averages the depth value assigned previously with the depth value corresponding to the time point T−1 and utilizes the averaged value to be actual depth value.

For example, it is assumed herein that the depth generator 140 assigned a depth value, 190, for pixels corresponding to the image object 310L in the left-eye image 300L′, and assigned a depth value, 210, for pixels corresponding to the image object 310L in the left-eye image 300L according to the spatial motion vector VS1 of the image object 310L. If the temporal motion vector VL1 is less than the predetermined value TTH2, the depth generator 140 may rectify the depth values for pixels corresponding to the image object 310L in the left-eye image 300L to be the average of 210 and 190, i.e., 200 in this case. The above averaging operation causes the change of depth value of a particular image object between two images of approaching time points to become smoother, thereby improving the image quality of the synthesized 3D images.

In implementations, the image motion detector 130 may detect image motion of the image object 310L between the left-eye image 300L and the left-eye image 300L″ in the operation 240 to generate a temporal motion vector VL2 to replace the temporal motion vector VL1 described previously. Alternatively, the image motion detector 130 may detect image motion of the image object 310R between the right-eye image 300R′ and the right-eye image 300R in the operation 240 to generate a temporal motion vector VR1 to replace the temporal motion vector VL1. In addition, the image motion detector 130 may detect image motion of the image object 310R between the right-eye image 300R and the right-eye image 300R″ in the operation 240 to generate a temporal motion vector VR2 to replace the temporal motion vector VL1.

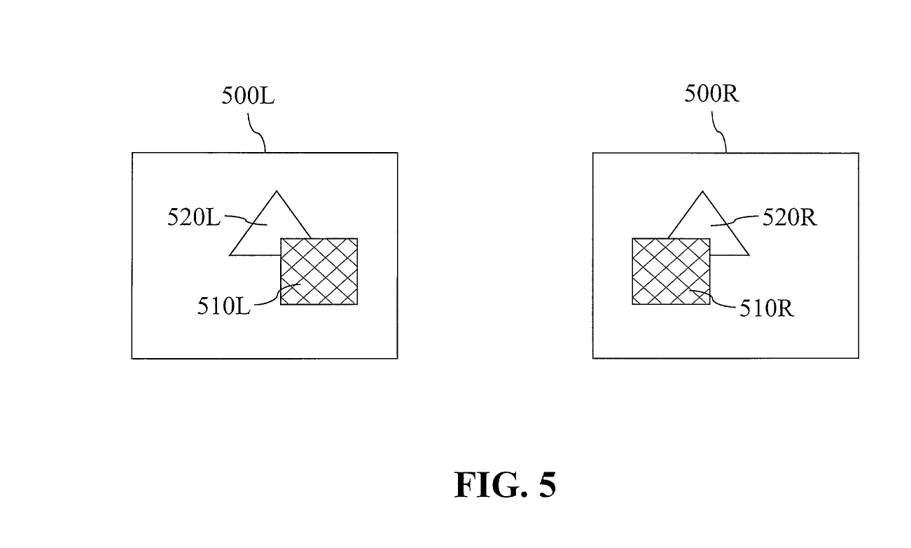

According to the operations elaborated previously, the image motion detector 130 generates a plurality of temporal motion vectors and a plurality of spatial motion vectors corresponding to a plurality of image objects in the left-eye image 300L and/or the right-eye image 300R, so that the depth generator 140 is able to calculate respective depth values of the image objects and generate a left-eye depth map 500L corresponding to the left-eye image 300L and/or a right-eye depth map 500R corresponding to the right-eye image 300R, as shown in FIG. 5. A pixel area 510L and a pixel area 520L in the left-eye depth map 500L respectively correspond to the image object 310L and the image object 320L of the left-eye image 300L. Similarly, a pixel area 510R and a pixel area 520R in the right-eye depth map 500R respectively correspond to the image object 310R and the image object 320R of the right-eye image 300R. For the purpose of explanatory convenience in the following description, it is assumed herein that the depth generator 140 of this embodiment configures the depth value of pixels of the pixel areas 510L and 510R to be 200, and configures depth value of pixels of the pixel areas 520L and 520R to be 60.

In order to allow the observer of the 3D images to adjust the depth of the 3D images depending upon the observer's visual condition or requirement, the 3D image rendering apparatus 100 allows the observer to adjust the depth of 3D images through a remote control or other control interface so as to provide better viewing experience to the observer with improved viewing quality and comfort. Therefore, the command receiving device 150 receives a depth adjusting command from a remote control or other control interface operated by the user in operation 260.

Then, the image rendering device 160 performs operation 270 to adjust positions of image objects in the left-eye image 300L and the right-eye image 300R according to the depth adjusting command to generate a new left-eye image and a new right-eye image for forming a new 3D image with adjusted depth configuration.

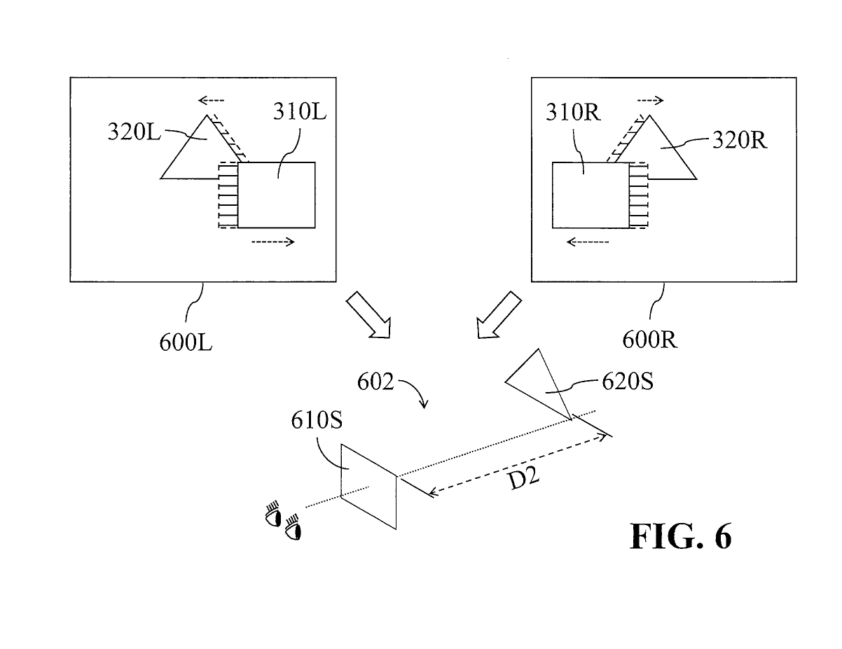

For the purpose of explanatory convenience in the following description, it is assumed herein that the depth adjusting command is intended to enhance the stereo effect of the 3D images, i.e., to enlarge the depth difference between different image objects of the 3D image. In this embodiment, the image rendering device 160 adjusts the positions of the image objects 310L and 320L of the left-eye image 300L and the image objects 310R and 320R of the right-eye image 300R according to the depth adjusting command, to generate a new left-eye image 600L and a new right-eye image 600R as shown in FIG. 6. In this embodiment, the image rendering device 160 moves the image object 310L rightward and moves the image object 320L leftward when generating the new left-eye image 600L. The image rendering device 160 moves the image object 310R leftward and moves the image object 320R rightward when generating the new right-eye image 600R. In implementations, the moving direction of each image object is relevant to the depth adjusting direction indicated by the depth adjusting command, and the moving distance of each image object is relevant to the degree of depth adjustment indicated by the depth adjusting command and the original depth value of the image object.

The new left-eye image 600L and the new right-eye image 600R form a 3D image 602 when displayed by a display apparatus (not shown) of the subsequent stage. In this embodiment, the image object 310L of the left-eye image 600L and the image object 310R of the right-eye image 600R form a 3D image object 610S of the 3D image 602, and the image object 320L of the left-eye image 600L and the image object 320R of the right-eye image 600R form a 3D image object 620S of the 3D image 602 when displaying. According to the adjusting directions of image objects described previously, the depth of the 3D image object 610S in the 3D image 602 is greater than the depth of the 3D image object 310S in the 3D image 302. That is, the observer would perceive that the 3D image object 610S is closer to him/her than the 3D image object 310S. On the other hand, the depth of the 3D image object 620S in the 3D image 602 is lighter than the depth of the 3D image object 320S in the 3D image 302. That is, the observer would normally perceive that the 3D image object 620S is further away from him/her than the 3D image object 310S.

As a result, assuming that the depth value distance between the 3D image objects 310S and 320S in the 3D image 302 perceived by the observer is D1, the depth value distance between the 3D image objects 610S and 620S in the new 3D image 602 perceived by the observer would become D2, which is greater than the depth value distance D1.

The foregoing operations of generating the new left-eye image 600L and the new right-eye image 600R by moving image objects may result in void image areas in the edge portion of the image objects. To improve the quality of 3D images, the image rendering device 160 may generate data required for filling the void image areas of the left-eye image according to a portion of data of the right-eye image, and generate data required for filling the void image areas of the right-eye image according to a portion of data of the left-eye image.

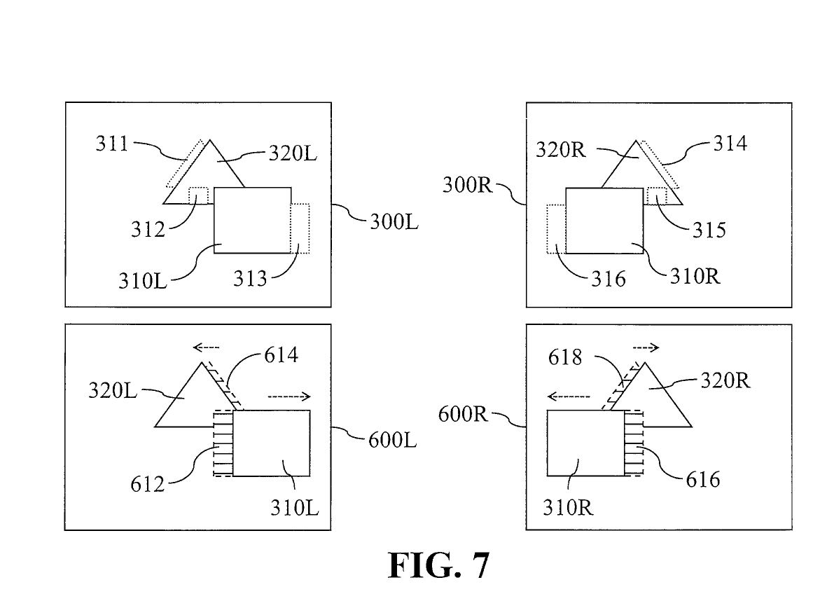

FIG. 7 is a simplified schematic diagram illustrating the operation of filling void image areas in the left-eye image and the right-eye image according to an example embodiment. As described previously, the image rendering device 160 moves the image object 310L rightward and moves the image object 320L leftward when generating the new left-eye image 600L, and moves the image object 310R leftward and moves the image object 320L rightward when generating the new right-eye image 600R. The foregoing moving operation of image objects may result in a void image area 612 in the edge of the image object 310L, a void image area 614 in the edge of the image object 320L, a void image area 616 in the edge of the image object 310R, and a void image area 618 in the edge of the image object 320R. In this embodiment, the image rendering device 160 may fill the void image area 612 of the new left-eye image 600L with pixel values of the image areas 315 and 316 of the original right-eye image 300R, and may fill the void image area 614 of the new left-eye image 600L with pixel values of the image area 314 of the original right-eye image 300R. Similarly, the image rendering device 160 may fill the void image area 616 of the new right-eye image 600R with pixel values of the image areas 312 and 313 of the original left-eye image 300L, and may fill the void image area 618 of the new right-eye image 600R with pixel values of the image area 311 of the original left-eye image 300L.

In implementations, the image rendering device 160 may perform interpolation operations to generate new pixel values required for filling the void image areas of the new left-eye image 600L and the new right-eye image 600R by referencing to the pixel values of the original left-eye image 300L and the original right-eye image 300R, the pixel values of the left-eye image 300L′ and the right-eye image 300R′, and/or the pixel values of the left-eye image 300L″ the right-eye image 300R″.

Some traditional image processing methods utilize a 2D image of a single viewing angle (such as one of the left-eye image and the right-eye image) to generate image data of another viewing angle. In such case, when the image objects of the single viewing angle are moved, it is difficult to effectively fill the resulting void image areas, thereby degrading the image quality in the edges of the image objects. In comparison with the traditional methods, the disclosed image rendering device 160 generates new left-eye image and right-eye image using reciprocal image data of the original right-eye image and left-eye image. In this way, the image quality of 3D images can be effectively improved, especially in the edge portions of image objects.

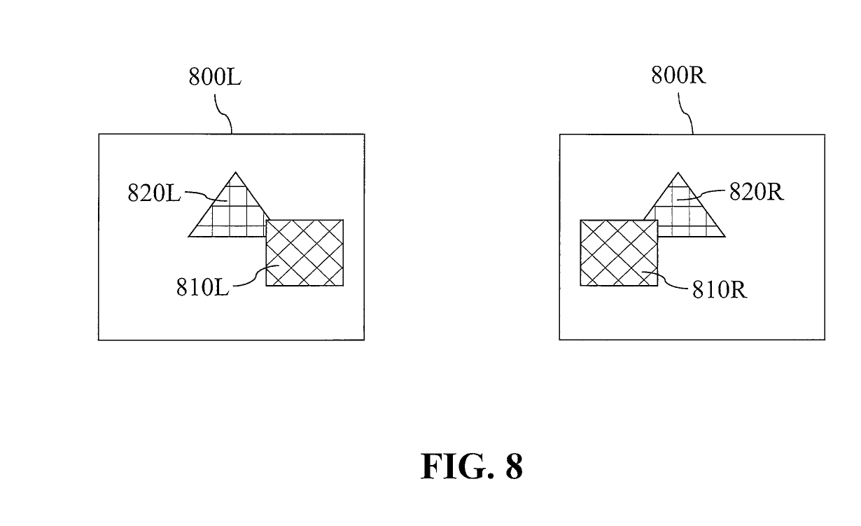

In operation 280, the image rendering device 160 decreases the depth value of at least one image object and/or increases the depth value of at least one of other image objects according to the depth adjusting command. For example, in the embodiment shown in FIG. 8, the image rendering device 160 may increase the depth value of pixels in the pixel areas 810L and 810R corresponding to the image objects 310L and 310R to be 270, and decrease the depth value of pixels in the pixel areas 820L and 820R corresponding to the image objects 320L and 320R to be 40, to generate a left-eye depth map 800L corresponding to the new left-eye image 600L and/or a right-eye depth map 800R corresponding to the new right-eye image 600R.

Then, depending upon the design of circuit in the subsequent stage, the output device 170 may transmit the new left-eye image 600L and the new right-eye image 600R generated by the image rendering device 160 as well as the adjusted left-eye depth map 800L and/or the right-eye depth map 800R to the circuit in the subsequent stage for displaying or further processing.

If the depth adjusting command received by the command receiving device 150 is intended to degrade the stereo effect of the 3D images, i.e., to reduce the depth difference between different image objects of the 3D image, the image rendering device 160 may perform the previous operation 270 in opposite direction. For example, the image rendering device 160 may move the image object 310L leftward and move the image object 320L rightward when generating the new left-eye image. The image rendering device 160 may move the image object 310R rightward and move the image object 320R leftward when generating the new right-eye image. As a result, the depth difference between a new 3D image object formed by the image objects 310L and 310R and another new 3D image formed by the image objects 320L and 320R can be reduced. Similarly, the image rendering device 160 may perform the previous operation 280 in opposite direction.

Please note that in the foregoing embodiments, the image rendering device 160 adjusts the position and depth of the image object 310L in opposite direction to the image object 320L, and adjusts the position and depth of the image object 310R in opposite direction to the image object 320R according to the depth adjusting command. This merely an example rather than a restriction to the practical applications. In implementations, the image rendering device 160 may adjust the position and/or depth value of only a portion of image objects while maintaining the position and/or depth value of other image objects.

For example, when the depth adjusting command requests the 3D image rendering apparatus 100 to enhance the stereo effect of 3D images, the image rendering device 160 may only move the image object 310L rightward and move the image object 310R leftward, but not changing the positions and depth values of the image objects 320L and 320R. Alternatively, the image rendering device 160 may only move the image object 320L leftward and move the image object 320R rightward, but not changing the positions and depth values of the image objects 310L and 310R. The above two adjustments can both increase the depth difference between different image objects of the 3D image.

Alternatively, the image rendering device 160 may only increase the depth values of the image objects 310L and 310R, but not changing the depth values and positions of the image objects 320L and 320R. On the contrary, the image rendering device 160 may only decrease the depth values of the image objects 320L and 320R, but not changing the depth values and positions of the image objects 310L and 310R. The above two adjustments can both increase the depth difference between different image objects of the 3D image.

In another embodiment, the image rendering device 160 may move the image object 310L and the image object 320L toward the same direction with different distance when generating the new left-eye image 600L, and move the image object 310R and the image object 320R toward another direction with different distance when generating the new right-eye image 600R. In this way, the image rendering device 160 could also change the depth difference between different image objects of the 3D image.

In yet another embodiment, the image rendering device 140 may change the depth difference between different image objects of the 3D image by adjusting the depth values of pixels corresponding to the image objects 310L, 320L, 310R, and 320R toward the same direction with different adjusting amounts. For example, the image rendering device 140 may increase the depth values of pixels corresponding to the image objects 310L, 320L, 310R, and 320R, but the depth value increments of pixels of the image objects 310L and 310R are greater than the depth value increments of pixels of the image objects 320L and 320R, to enlarge the depth difference between different image objects of the 3D image. In another example, the image rendering device 140 may decrease the depth values of pixels corresponding to the image object 310L, 320L, 310R, and 320R, but the depth value decrements of pixels of the image objects 310L and 310R are greater than the depth value decrements of pixels of the image objects 320L and 320R, to reduce the depth difference between different image objects of the 3D image.

The execution order of the operations in the previous flowchart 200 is merely an example, rather than a restriction to the practical implementations. For example, in another embodiment, the image rendering device 160 may perform the operation 280 first to adjust the depth values of image objects according to the depth adjusting command and then perform the operation 270 to calculate corresponding moving distance of each image object according to the adjusted depth value and move the image objects accordingly. That is, the execution order of operations 270 and 280 may be swapped. Additionally, one of the operations 270 and 280 may be omitted in some embodiments.

In addition to allow the observer to adjust the stereo effect of 3D images, i.e., the depth difference between different 3D image objects, as needed, the disclosed 3D image rendering apparatus 100 is capable of supporting glasses-free multi-view auto stereo display application. As elaborated previously, the image motion detector 130 is able to generate corresponding left-eye depth map 500L and/or right-eye depth map 500R according to the received left-eye image 300L and right-eye image 300R. The image rendering device 160 may synthesize a plurality of left-eye images and a plurality of right-eye images respectively corresponding to a plurality of viewing points according to the left-eye image 300L, the right-eye image 300R, the left-eye depth map 500L, and/or the right-eye depth map 500R. The output device 170 may transmit the generated left-eye images and right-eye images to an appropriate display device to achieve the glasses-free multi-view auto stereo display function.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A 3D image rendering apparatus comprising:
an image motion detector for detecting temporal image motion of a target image object in a first left-eye image or a first right-eye image to generate a temporal motion vector for the target image object, and for performing an image motion detection on the first left-eye image and the first right-eye image to generate a spatial motion vector for the target image object, wherein the first left-eye image and the first right-eye image are capable of forming a first 3D image;
a depth generator, coupled with the image motion detector, for generating a depth value for the target image object based on the temporal motion vector and the spatial motion vector;
a command receiving device for receiving a depth adjusting command; and
an image rendering device, coupled with the command receiving device, for adjusting positions of at least a portion of image objects in the first left-eye image and the first right-eye image to synthesize a second left-eye image and a second right-eye image capable of forming a second 3D image.

2. The 3D image rendering apparatus of claim 1, wherein the image rendering device generates a portion of data of the second left-eye image according to a portion of data of the first right-eye image, and generates a portion of data of the second right-eye image according to a portion of data of the first left-eye image.

3. The 3D image rendering apparatus of claim 2, wherein a first image object of the first left-eye image and a second image object of the first right-eye image are for forming a first 3D image object in the first 3D image, a third image object of the first left-eye image and a fourth image object of the first right-eye image are for forming a second 3D image object in the first 3D image, the first image object and the second image object are for forming a third 3D image object in the second 3D image, and the third image object and the fourth image object are for forming a fourth 3D image object in the second 3D image.

4. The 3D image rendering apparatus of claim 3, wherein the image receiving device performs image motion detection operations on the first left-eye image and the first right-eye image to generate a plurality of candidate motion vectors corresponding to the target image object, and selects one of the plurality of candidate motion vectors as a current spatial motion vector for the target image object according to spatial motion vectors of the target image object in the left-eye image and the right-eye image with respect to other time points.

5. The 3D image rendering apparatus of claim 3, wherein the image rendering device adjusts positions of the first, second, third, and fourth image object to render depth of the third 3D image object in the second 3D image to be greater than depth of the first 3D image object in the first 3D image, and to render depth of the fourth 3D image object in the second 3D image to be lighter than depth of the second 3D image object in the first 3D image.

6. The 3D image rendering apparatus of claim 3, wherein the image rendering device adjusts positions of only a portion of image objects of the first left-eye image and the first right-eye image to render depth of the third 3D image object in the second 3D image to be different from depth of the first 3D image object in the first 3D image, and to render depth of the fourth 3D image object in the second 3D image to be equal to depth of the second 3D image object in the first 3D image.

7. The 3D image rendering apparatus of claim 3, wherein the image rendering device adjusts positions of at least a portion of image objects of the first left-eye image toward a direction and adjusts positions of at least a portion of image objects of the first right-eye image toward another direction to render depth difference between the third 3D image object and the fourth 3D image object in the second 3D image to be different from depth difference between the first 3D image object and the second 3D image object in the first 3D image.

8. The 3D image rendering apparatus of claim 3, wherein the image rendering device moves the first image object rightward and moves the third image object leftward when synthesizing the second left-eye image, and the image rendering device moves the second image object leftward and moves the fourth image object rightward when synthesizing the second right-eye image.

9. The 3D image rendering apparatus of claim 3, wherein the image rendering device adjusts positions of only a portion of image objects while maintaining positions of other image objects when synthesizing the second left-eye image.

10. The 3D image rendering apparatus of claim 3, wherein the image rendering device moves the first image object and the third image object toward a direction with different distance when synthesizing the second left-eye image, and the image rendering device moves the second image object and the fourth image object toward another direction with different distance when synthesizing the second right-eye image.

11. A 3D image rendering apparatus comprising:
an image motion detector for detecting temporal image motion of each target image object in a left-eye image or a right-eye image to generate a temporal motion vector for each target image object, and for performing an image motion detection on the left-eye image and the right-eye image to generate a spatial motion vector for each target image object, wherein the left-eye image and the right-eye image are capable of forming a 3D image;
a depth generator, coupled with the image motion detector, for generating a depth map according to a plurality of temporal motion vectors and a plurality of spatial motion vectors generated by the image motion detector; and
an image rendering device for synthesizing a plurality of left-eye images and a plurality of right-eye images respectively corresponding to a plurality of viewing points according to the left-eye image, the right-eye image, and the depth map.

12. A 3D image rendering apparatus comprising:
an image motion detector for detecting temporal image motion of each target image object in a left-eye image or a right-eye image to generate a temporal motion vector for each target image object, and for performing an image motion detection on the left-eye image and the right-eye image to generate a spatial motion vector for each target image object, wherein the left-eye image and the right-eye image are capable of forming a 3D image;
a depth generator, coupled with the image motion detector, for generating a first depth map according to a plurality of temporal motion vectors and a plurality of spatial motion vectors generated by the image motion detector;
a command receiving device for receiving a depth adjusting command; and
an image rendering device, coupled with the command receiving device, for adjusting depth values of at least a portion of pixels of the first depth map to generate a second depth map.

13. The 3D image rendering apparatus of claim 12, wherein the image rendering device increases depth values of a portion of pixels and decreases depth values of another portion of pixels according to the depth adjusting command.

14. The 3D image rendering apparatus of claim 12, wherein the image rendering device adjusts depth values of only a portion of pixels while maintaining depth values of other pixels according to the depth adjusting command.

15. The 3D image rendering apparatus of claim 12, wherein the image rendering device adjusts pixel values of two pixels toward a same direction with different adjusting amounts according to the depth adjusting command.
